(19) United States
(12) Patent Application Publication
(10) Pub. No.: US 2014/0178200 A1
(43) Pub. Date: Jun. 26, 2014

(54) INDICATING CIRCUIT FOR INDICATING ROTATION SPEED OF A FAN AND ELECTRONIC DEVICE USING THE INDICATING CIRCUIT

(71) Applicants: HON HAI PRECISION INDUSTRY CO., LTD., New Taipei (TW); HONG FU JON PRECISION INDUSTRY (WUhAN) CO., LTD., Wuhan (CN)

(72) Inventors: YONG-ZHAO HUANG, Wuhan (CN); JIN-LIANG XIONG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/014,297

(22) Filed: Aug. 29, 2013

(30) Foreign Application Priority Data
Dec. 21, 2012 (CN) 2012105608279

(51) Int. Cl. F04D 27/00; G01P 13/00

(52) U.S. Cl. CPC F04D 27/004; G01P 13/00
USPC 416/39; 416/61; 340/672

(57) ABSTRACT

An indicating circuit for indicating the rotation speed of a fan includes a rotation speed indicating module connected to the fan and receiving rotation speed signals from the fan. The indicating circuit includes a switch and a light emitting element. If the received signal is a high level signal, the switch is turned on, and the light emitting element emits light. If the reeived signal is a low level signal, the switch is turned off, and the light emitting element does not emit light.

### BACKGROUND

1. Technical Field

The present disclosure relates to indicating circuits and, particularly, to an indicating circuit for indicating rotation speed of a fan.

2. Description of Related Art

Fans are commonly used to cool electronic devices. Fans of an electronic device are housed in a housing of the electronic device, and are invisible for users, thus users cannot know whether the fans are running normally.

Therefore, it is desirable to provide an indicating circuit to indicate the working state of the fan.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding units throughout the several views.

FIG. 1 is a block diagram of an electronic device having an indicating circuit for indicating the rotation speed of a fan, in accordance with an exemplary embodiment.

FIG. 2 is a circuit diagram of the indicating circuit of FIG. 1.

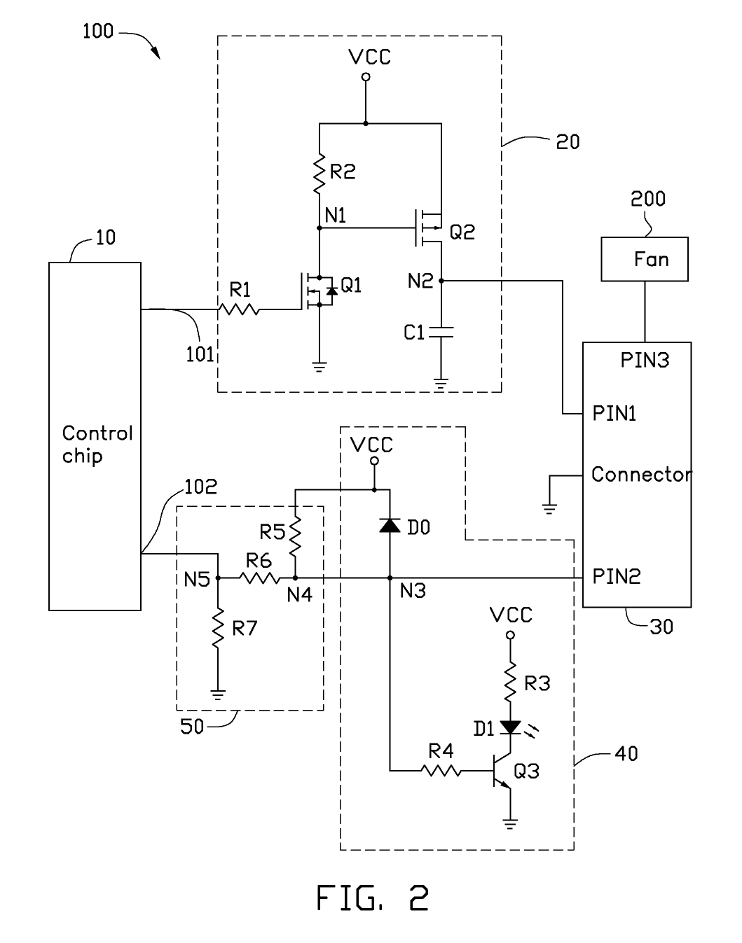

### DETAILED DESCRIPTION

Embodiments of the present disclosure are described with reference to the accompanying drawings.

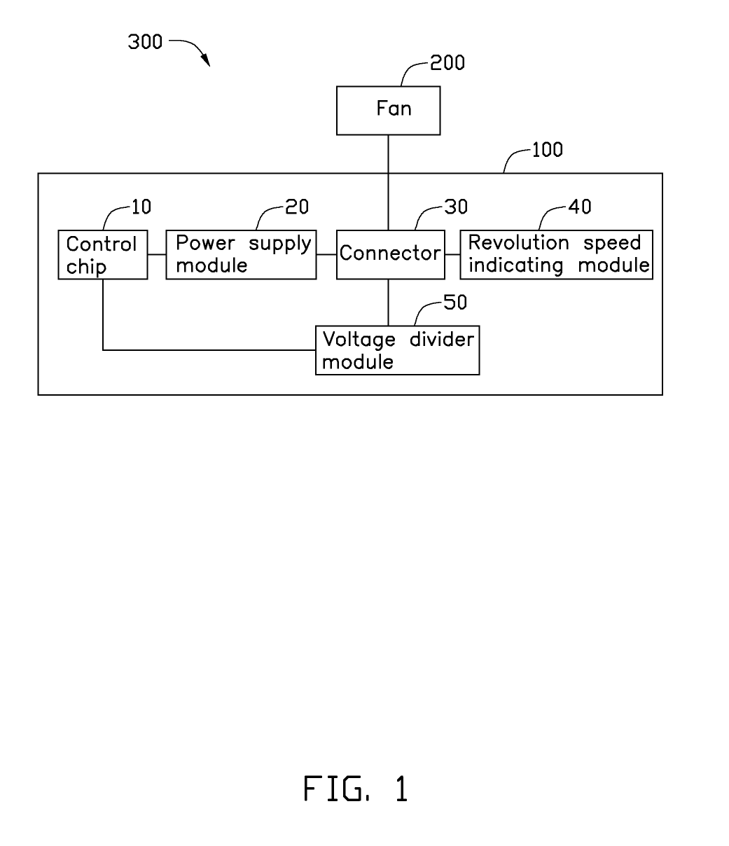

FIG. 1 shows an embodiment of the present disclosure of an electronic device 300 including an indicating circuit 100. The circuit 100 is to indicate the rotation speed of a fan 200 of the electronic device 300. The circuit 100 includes a control chip 10, a power supply module 20, a connector 30, a rotation speed indicating module 40, and a voltage divider module 50.

The control chip 10 is used to output first pulse voltage signals according to environment temperature. In this embodiment, the duty cycle of the first pulse voltage signals varies with the change of the environment temperature. It can be understood that the environment temperature may be the temperature of the electronic device 300 or the temperature of a central processing unit (CPU) of the electronic device 300. In this embodiment, the duty cycle of the first pulse voltage signals increases when the environment temperature increases, and the duty cycle of the first pulse voltage signals decreases when the environment temperature decreases.

The power supply module 20 is connected to the control chip 10. The fan 200 is connected to the power supply module 20 via the connector 30. The power supply module 20 supplies power to the fan 200 according to the first pulse voltage signals output by the control chip 10. In this embodiment, the power supply module 20 provides power to the fan 200 via the connector 30 if the control chip 10 outputs a logic high voltage signal. The connector 30 is further connected to the rotation speed indicating module 40, and transmits rotation speed signals generated by the fan 200 to the rotation speed indicating module 40. In this embodiment, the rotation speed signals are second pulse voltage signals. The rotation speed indicating module 40 includes a light emitting element D1, and the light emitting element D1 is controlled to emit light according to the rotation speed signals generated by the fan 200. The light emitting element D1 is arranged on a position of the electronic device 300 where the light emitted by the light emitting element D1 can be seen by users, such as arranged on a frame (not shown) housing the display (not shown) of the electronic device 300. In this embodiment, the light emitting element D1 is a light emitting diode.

In this embodiment, the control chip 10 includes an output terminal 101 and an input terminal 102. The input terminal 102 is connected to a Platform Environment Control Interface (PECI) (not shown) of the CPU of the electronic device 300. When the temperature of the CPU changes, signals indicating environment change output by the PECI changes. The control chip 10 receives the signals output by the PECI via the input terminal 102, and changes the duty cycle of the first pulse voltage signals output through the output terminal 101 according to the received signals.

The power supply module 20 includes a voltage supply terminal VCC, a first resistor R1, a second resistor R2, a first metal-oxide-semiconductor field effect transistor (MOSFET) Q1, a second MOSFET Q2, and a capacitor C1. The gate of the first MOSFET Q1 is connected to the output terminal 101 via the first resistor R1. The drain of the first MOSFET Q1 is connected to the voltage supply terminal VCC via the second resistor R2. An intersection between the drain of the first MOSFET Q1 and the second resistor R2 forms a first node N1. The source of the first MOSFET Q1 is grounded. The gate of the second MOSFET Q2 is connected to the first node N1 via the second resistor R2, the drain of the second MOSFET Q2 is connected to the voltage supply terminal VCC, the source of the second MOSFET Q2 is connected to one end of the first capacitor C1, and the other end of the capacitor C1 is grounded. An intersection between the source of the second MOSFET Q2 and the capacitor C1 forms a second node N2. In this embodiment, the first MOSFET Q1 is NMOS, and the second MOSFET Q2 is PMOS.

The connector 30 includes a first pin PIN1, a second pin PIN2, and a third pin PIN3. The first pin PIN1 is connected to the second node N2, and the third pin PIN3 is connected to the fan 200, accordingly the power supply module 20 can supply power to the fan 200 via the connector 30. In detail, when the control chip 10 outputs a high level voltage signal, the first MOSFET Q1 and the second MOSFET Q2 are turned on, the voltage supply terminal VCC supplies power to the fan 200 via the connector 30, and the capacitor C1 is charged by the voltage supply terminal VCC. When the control chip 10 outputs a low level voltage signal, the first MOSFET Q1 and the second MOSFET Q2 are turned off, and the capacitor C1 discharges to supply power to the fan 200 via the connector 30. When the temperature increases, the duty cycle of the first pulse signals output by the control chip 10 is increased, and the charging time of the voltage supply terminal VCC charging the capacitor C1 increases. When the capacitor C1 is charged for a relative longer time, the voltage of the capacitor C1 becomes higher, thus when the capacitor C1 discharges, the capacitor C1 can provide higher voltage to the fan 200, and the rotation speed of the fan 200 correspondingly increases. In contrast, when the temperature decreases, the duty cycle of the first pulse signals output by the control chip 10 reduces, and the charging time of the voltage supply terminal VCC charging the capacitor C1 reduces. When the capacitor C1 is charged for a relative shorter time, the voltage of the capacitor C1 becomes lower, thus when the capacitor C1 discharges, the capacitor C1 provides lower voltage to the fan 200, and the rotation speed of the fan 200 correspondingly decreases.

The rotation speed indicating module 40 includes a diode D0, a third resistor R3, a fourth resistor R4, a switch Q3, and a light emitting diode D1. The third resistor R3, the light emitting diode D1, and the switch Q3 are connected in series between the voltage supply terminal VCC and ground. In this embodiment, the switch Q3 is a transistor. In detail, the anode of the light emitting diode D1 is connected to the voltage supply terminal VCC via the third resistor R3, and the cathode of the light emitting diode D1 is connected to the collector of the transistor Q3. The base of the transistor Q3 is connected to the anode of the diode DO via the fourth resistor R4, and the cathode of the diode D0 is connected to the voltage supply terminal VCC. The emitter of the transistor Q3 is grounded. An intersection between the fourth resistor R4 and the diode DO form a third node N3. The second pin PIN2 of the connector 30 is connected to the third node N3.

When the fan 200 runs in a normal state, the fan 200 outputs a rotation speed signal to the connector 30. In this embodiment, the rotation speed signal is a second pulse voltage signal, and the frequency of the second pulse voltage signal is in proportion to the rotation speed of the fan 200. The connector 30 outputs the rotation speed signal to the rotation speed indicating module 40 via the second pin PIN2. When the connector 30 outputs a high level voltage signal, the transistor Q3 is turned on, and the voltage supply terminal VCC supplies power to the light emitting diode D1. Thus, the light emitting diode D1 is turned on and emits light. When the connector 30 outputs a low level voltage signal, the transistor Q3 is turned off, and the light emitting diode D1 is turned off and does not emit light. Therefore, when the fan 200 runs in a normal state, the light emitting diode D1 flashes in a frequency in proportion to the rotation speed of the fan 200. Thus, users can know whether the fan 200 runs normally by viewing whether the light emitting diode D1 flashes normally.

The voltage divider module 50 includes a fifth resistor R5, a sixth resistor R6, and a seventh resistor R7 connected in series between the voltage supply terminal VCC and ground. An intersection between the fifth resistor R5 and the sixth resistor R6 forms a fourth node N4, and an intersection between the sixth resistor R6 and the seventh resistor R7 forms a fifth node N5. The second pin PIN2 of the connector 30 is connected to the fourth node N4. The fifth node N5 is connected to the input terminal 102 of the control chip 10. The voltage input to the control chip 10 is equal to the voltage of the seventh resistor R7. Thus, the control chip 10 is prevented from being damaged by high input voltage.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An indicating circuit for indicating a rotation speed of a fan of an electronic device, the indicating circuit comprising:
a rotation indicating module connected to the fan via a connector, and the rotation indicating module receiving rotation speed signals from the fan via the connector, wherein the received rotation speed signals are pulse voltage signals, and the frequency of the rotation speed signals is in proportion to the rotation speed of the fan; the rotation indicating module comprising a light emitting element and a switch connected in series between a voltage supply terminal and ground; when a received rotation speed signal is a high level voltage signal, the switch is turned on, and the voltage supply terminal supply power to the light emitting element, thus the light emitting element emits light; and when a received rotation speed signal is a low level voltage signal, the switch is turned off, and the light emitting element does not emit light.

2. The indicating circuit as described in claim 1, wherein the switch is a transistor.

3. The indicating circuit as described in claim 1, further comprising:
a control chip to output first pulse voltage signals according to environment temperature, wherein a duty cycle of the first pulse voltage signals changes according to the environment temperature;
a power supply module connected to the control chip; and
a connector to be connected between the power supply module and the fan, the power supply module supplying power to the fan according to the pulse signals outputted by the control chip.

4. The indicating circuit as described in claim 3, wherein the duty cycle of the first pulse voltage signals increases if the environment temperature increases, and the duty cycle of the first pulse voltage signals reduces if the environment temperature decreases.

5. The indicating circuit as described in claim 3, wherein the control chip comprises an output terminal, the power supply module comprises a voltage supply terminal, a first resistor, a second resistor, a first metal-oxide-semiconductor field effect transistor (MOSFET), a second MOSFET , and a capacitor, the gate of the first MOSFET is connected to the output terminal of the control chip via the first resistor, the drain of the first MOSFET is connected to the voltage supply terminal via the second resistor, an intersection between the drain of the first MOSFET and the second resistor forms a first node, the source of the first MOSFET is grounded, the gate of the second MOSFET is connected to the first node via the second resistor, the drain of the second MOSFET is connected to the voltage supply terminal, the source of the second MOSFET is connected to one end of the first capacitor, and the other end of the capacitor is grounded.

6. The indicating circuit as described in claim 5, wherein the first MOSFET is NMOS, and the second MOSFET is PMOS.

7. The indicating circuit as described in claim 5, wherein the connector comprises a first pin and a second pin, the first pin is connected to a second node formed by an intersection between the source of the second MOSFET and the capacitor.

8. The indicating circuit as described in claim 2, wherein the rotation speed indicating module comprises a diode, a third resistor, a fourth resistor, a transistor, and a light emitting diode; the anode of the light emitting diode is connected to the voltage supply terminal via the third resistor, and the cathode of the light emitting diode is connected to the collector of the transistor, the base of the transistor is connected to the anode of the diode via the fourth resistor, and the cathode of the diode is connected to the voltage supply terminal, the emitter of the transistor is grounded, the connection point between the fourth resistor and the diode form a third node, the second pin of the connector is connected to the third node.

9. The indicating circuit as described in claim 7, wherein the rotation speed indicating circuit further comprises a voltage divider module, the voltage divider module comprises a fifth resistor, a sixth resistor, and a seventh resistor connected in series between the voltage supply terminal and ground, an intersection between the fifth resistor and the sixth resistor forms a fourth node, and an intersection between the sixth resistor and the seventh resistor form a fifth node, the second pin of the connector is connected to the fourth node, and the fifth node is connected to the input terminal of the control chip.

10. An electronic device comprising:
a fan; and
an indicating circuit for indicating the rotation speed of the fan, the indicating circuit comprising a rotation indicating module connected to the fan via a connector, and the rotation indicating module receiving rotation speed signals from the fan via the connector, wherein the received rotation speed signals are pulse voltage signals, and the frequency of the rotation speed signals is in proportion to the rotation speed of the fan; the rotation indicating module comprising a light emitting element and a switch connected in series between a voltage supply terminal and ground; when a received rotation speed signal is a high level voltage signal, the switch is turned on, and the voltage supply terminal supply power to the light emitting element, thus the light emitting element emits light; when a received rotation speed signal is a low level voltage signal, the switch is turned off, and the light emitting element does not emit light.

11. The electronic device as described in claim 10, wherein the switch is a transistor.

12. The electronic device as described in claim 10, wherein the indicating circuit further comprises:
a control chip to output first pulse voltage signals according to environment temperature, wherein a duty cycle of the first pulse voltage signals changes according to the environment temperature;
a power supply module connected to the control chip; and
a connector to be connected between the power supply module and the fan, the power supply module supplying power to the fan according to the pulse signals outputted by the control chip.

13. The electronic device as described in claim 12, wherein the duty cycle of the first pulse voltage signals increases if the environment temperature increases, and the duty cycle of the first pulse voltage signals reduces if the environment temperature decreases.

14. The electronic device as described in claim 12, wherein the control chip comprises an output terminal, the power supply module comprises a voltage supply terminal, a first resistor, a second resistor, a first metal-oxide-semiconductor field effect transistor (MOSFET), a second MOSFET , and a capacitor, the gate of the first MOSFET is connected to the output terminal of the control chip via the first resistor, the drain of the first MOSFET is connected to the voltage supply terminal via the second resistor, an intersection between the drain of the first MOSFET and the second resistor forms a first node, the source of the first MOSFET is grounded, the gate of the second MOSFET is connected to the first node via the second resistor, the drain of the second MOSFET is connected to the voltage supply terminal, the source of the second MOSFET is connected to one end of the first capacitor, and the other end of the capacitor is grounded.

15. The electronic device as described in claim 14, wherein the first MOSFET is NMOS, and the second MOSFET is PMOS.

16. The electronic device as described in claim 14, wherein the connector comprises a first pin and a second pin, the first pin is connected to a second node formed by an intersection between the source of the second MOSFET and the capacitor.

17. The electronic device as described in claim 14, wherein the rotation speed indicating module comprises a diode, a third resistor, a fourth resistor, a transistor, and a light emitting diode; the anode of the light emitting diode is connected to the voltage supply terminal via the third resistor, and the cathode of the light emitting diode is connected to the collector of the transistor, the base of the transistor is connected to the anode of the diode via the fourth resistor, and the cathode of the diode is connected to the voltage supply terminal, the emitter of the transistor is grounded, the connection point between the fourth resistor and the diode form a third node, the second pin of the connector is connected to the third node.

18. The electronic device as described in claim 16, wherein the indicating circuit further comprises a voltage divider module, the voltage divider module comprises a fifth resistor, a sixth resistor, and a seventh resistor connected in series between the voltage supply terminal and ground, an intersection between the fifth resistor and the sixth resistor forms a fourth node, and an intersection between the sixth resistor and the seventh resistor form a fifth node, the second pin of the connector is connected to the fourth node, and the fifth node is connected to the input terminal of the control chip.
